(19) United States
(12) Patent Application Publication
(10) Pub. No.: US 2017/0104221 A1
(43) Pub. Date: Apr. 13, 2017

(54) METHOD FOR PRODUCING CORE-SHELL CATALYST FOR FUEL CELLS

(71) Applicants: Toyota Jidosha Kabushiki Kaisha, Toyota-shi Aichi-ken (JP); Brookhaven Science Associates, LLC, Upton, NY (US)

(72) Inventors: Makoto Adachi, Numazu-shi Shizuoka-ken (JP); Yasuyuki Ohki, Susono-shi Shizuoka-ken (JP); Tetsuya Ogawa, Mishima-shi Shizuoka-ken (JP); Radoslav Adzic, East Setauket, NY (US); Jia Xu Wang, East Setauket, NY (US); Yu Zhang, Center Moriches, NY (US)

(21) Appl. No.: 14/878,530

(22) Filed: Oct. 8, 2015

(51) Int. Cl. H01M 4/92

(52) U.S. Cl. CPC H01M 4/926

(57) ABSTRACT

The present invention is to provide a method for producing a core-shell catalyst for fuel cells, which is configured to facilitate shell deposition by, at the time of shell deposition, decreasing an oxidation-reduction potential lower than ever before. Disclosed is a method for producing a core-shell catalyst for fuel cells, wherein the method comprises: a bubbling step of bubbling hydrogen into a mixture A containing a core fine particle-supported carbon and alcohol; a first refluxing step of refluxing the mixture A after the bubbling step; a mixing step of preparing a mixture B by, after the first refluxing step, mixing the mixture A having a temperature that is lower than that in the first refluxing step with a shell material; and a second refluxing step of refluxing the mixture B.

This invention was made under CRADA No. BNL-C-11-05 between Toyota Motor Corporation and Brookhaven National Laboratory operated for the United States Department of Energy. This invention was made with Government support under contract numbers DE-AC02-98CH10886 and DE-SC0012704, awarded by the U.S. Department of Energy.

The Government has certain rights in this invention.

### TECHNICAL FIELD

The present invention relates to a method for producing a core-shell catalyst for fuel cells, which is configured to facilitate shell deposition by, at the time of shell deposition, decreasing an oxidation-reduction potential lower than ever before.

### BACKGROUND ART

As a catalyst cost reducing technique, a technique relating to a core-shell catalyst is known, which has a structure including a core fine particle and a shell covering the core fine particle (i.e., the core-shell structure). By using a relatively inexpensive material for the core fine particles of the core-shell catalyst, the cost of the inside of the core-shell catalyst, which rarely involves in catalyst reaction, can be kept low. In Patent Literature 1, a method for producing a core-shell catalyst for fuel cells is disclosed, which is a method for electrochemically covering palladium-containing particles supported on a carbon support with a platinum-containing layer, which is the outermost layer, after the carbon support is made finer.

Since the prior art disclosed in Patent Literature 1 includes complicated processes, it is needed to simplify the production processes and decrease the production costs. Meanwhile, a method for covering palladium surface with platinum is disclosed in Non-patent Literature 1, in which a suspension composed of a palladium-supported carbon suspended in alcohol is refluxed, thereby allowing the alcohol to function as a reducing agent and covering the palladium surface with platinum.

### CITATION LIST

Patent Literature 1: Japanese Patent Application Laid-Open No. 2013-239331

Non-patent Literature 1: Zhang, Yu et al., ACS Catalysis, 2014, 4, 738-742

### SUMMARY OF INVENTION

### Technical Problem

It is known that the surface of palladium is oxidized in the air to produce oxides (such as PdO) thereon. When oxides are attached to the surface, a platinum shell is less likely to deposit thereon. Accordingly, it is general to reduce the palladium surface in advance.

In Non-patent Literature 1, it is disclosed to reduce the palladium surface in advance, before the deposition of a platinum shell, using the reducing ability of refluxed ethanol.

However, a sufficient amount of platinum is not always deposited even by the method disclosed in Non-patent Literature 1. The reason is presumed as follows.

As is clear from the experimental result of the below-described Comparative Example 1 (FIG. 5), in a conventional method as disclosed in Non-patent Literature 1, palladium is reduced under a relatively high oxidation-reduction potential (about 0.1 V (vs. RHE) or more). From the result of Comparative Example 1 shown in FIG. 2, it cannot be said that the catalyst mass activity of a core-shell catalyst obtained by a conventional method is particularly high. The reason is presumed to be that oxides that could not be removed (such as PdO) are present on the surface of the thus-obtained palladium.

The present invention was achieved in light of the above circumstances relating to prior palladium surface reduction. An object of the present invention is to provide a method for producing a core-shell catalyst for fuel cells, which is configured to facilitate shell deposition by, at the time of shell deposition, decreasing an oxidation-reduction potential lower than ever before.

### Solution to Problem

The method for producing a core-shell catalyst for fuel cells according to the present invention comprises: a bubbling step of bubbling hydrogen into a mixture A containing a core fine particle-supported carbon and alcohol; a first refluxing step of refluxing the mixture A after the bubbling step; a mixing step of preparing a mixture B by, after the first refluxing step, mixing the mixture A having a temperature that is lower than that in the first refluxing step with a shell material; and a second refluxing step of refluxing the mixture B.

### Advantageous Effects of Invention

According to the present invention, by bubbling hydrogen into the mixture A in advance, the oxidation-reduction potential in the mixture B at the time of the second refluxing step can be decreased. As a result, a shell can be deposited more easily on the surface of the core fine particles than ever before.

### BRIEF DESCRIPTION OF DRAWINGS

FIG. 1 is a graph showing the transition of oxidation-reduction potential (ORP) in Example 1.

FIG. 2 is a bar graph comparing the catalyst mass activity (A/g-Pt) of the core-shell catalyst for fuel cells of Example 1 to that of Comparative Example 1.

FIG. 3 is a view showing the cyclic voltammograms of the samples of Reference Example 1 and Reference Comparative Example 1, which are overlapped on each other.

FIG. 4 is a bar chart comparing the electrochemically active surface area (ECSA) of palladium in the sample of Reference Example 1 to that of Reference Comparative Example 1.

FIG. 5 is a graph showing the transition of oxidation-reduction potential (ORP) in Comparative Example 1.

### DESCRIPTION OF EMBODIMENTS

The method for producing a core-shell catalyst for fuel cells according to the present invention comprises: a bubbling step of bubbling hydrogen into a mixture A containing a core fine particle-supported carbon and alcohol; a first refluxing step of refluxing the mixture A after the bubbling step; a mixing step of preparing a mixture B by, after the first refluxing step, mixing the mixture A having a temperature that is lower than that in the first refluxing step with a shell material; and a second refluxing step of refluxing the mixture B.

The present invention includes (i) the bubbling step, (ii) the first refluxing step, (iii) the mixing step, and (iv) the second refluxing step. The present invention is not limited to these four steps only. In addition to the four steps, the present invention can include the below-described filtering step, washing step and drying step, for example.

Hereinafter, the steps (i) to (iv) and other steps will be described in order.

1. Bubbling step

This is a step of bubbling hydrogen into a mixture A containing a core fine particle-supported carbon and alcohol.

As the core material used for the core fine particles, palladium, gold, silver and alloys thereof can be used. Of them, palladium or palladium alloy is preferred as the core material, and palladium is more preferred.

The method for producing the core fine particle-supported carbon is not particularly limited. The carbon can be produced by known methods such as prior arts. For example, as the method for producing palladium-supported carbon, the method disclosed in Patent Literature 1 can be used. The type of the carbon, which serves as a support, can be determined by reference to prior arts.

In this step, alcohol is used as a dispersion medium.

In the alcohol reduction method, to remove oxides from the surface of core fine particles, alcohol (dispersion medium) is used as a reducing agent. Conventionally, any special treatment has not been carried out on the mixture containing core fine particles and alcohol, before refluxing. Therefore, even at the time of refluxing, the oxidation-reduction potential of the reaction mixture remains high, and the reaction mixture cannot be sufficiently reduced.

In the present invention, using the characteristics of hydrogen gas as a reducing agent, hydrogen bubbling is carried out on the mixture A. As a result, the oxidation-reduction potential of the reaction mixture can be kept lower than ever before, so that the reaction mixture can be sufficiently reduced.

Ethanol is preferred as the alcohol, because it has sufficiently high reducing ability at the time of refluxing.

The reason why the reaction mixture is sufficiently reduced by the prior hydrogen bubbling, is as follows.

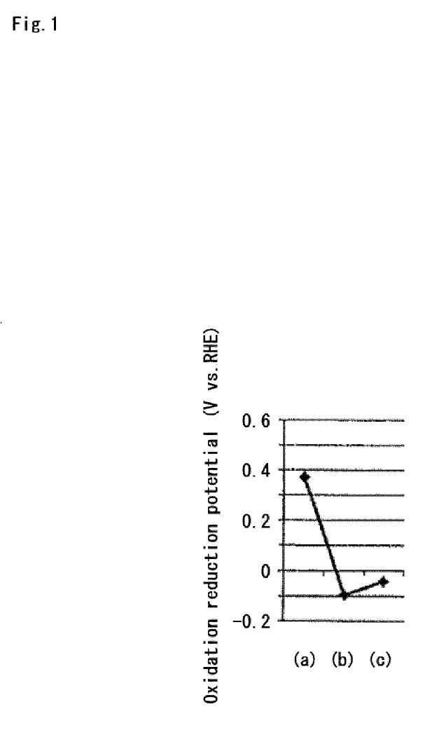

As is clear from the experimental result of the below-described Example 1 (FIG. 1), by carrying out the hydrogen bubbling, the oxidation-reduction potential of the mixture A can be decreased to 0 V (vs. RHE) or less. Accordingly, it is presumed that oxides can be cleared away from the core fine particle surface by the subsequent refluxing. A shell can be easily deposited on such a core fine particle surface from which oxides have been removed in advance.

A concrete example of the hydrogen bubbling is as follows: hydrogen gas is supplied into the mixture A at a flow rate of 20 mL/min or more and 2,000 mL/min or less, with respect to 1 L of the dispersion medium, for 5 minutes or more and 5 hours or less.

In this step, it is preferable to carry out nitrogen bubbling on the mixture A at least one of before and after the hydrogen bubbling.

The nitrogen bubbling carried out before the hydrogen bubbling, is carried out for removal of gas (such as air) dissolved in the alcohol in the mixture A. On the other hand, the nitrogen bubbling carried out after the hydrogen bubbling, is carried out for removal of hydrogen left in the alcohol by the hydrogen bubbling.

A concrete example of the nitrogen bubbling is as follows: nitrogen gas is supplied into the mixture A at a flow rate of 20 mL/min or more and 2,000 mL/min or less, with respect to 1 L of the dispersion medium, for 5 minutes or more and 5 hours or less. This example is applicable before or after the hydrogen bubbling.

2. First refluxing step

This is a step of refluxing the mixture A after the bubbling step.

At the time of refluxing, the boiling point of the alcohol serves as the upper limit of the temperature of the reaction mixture. Therefore, the temperature of the reaction mixture depends on the type of the alcohol. The boiling point of the alcohol is more preferably 78° C. or more.

At the time of refluxing, the heating temperature varies depending on a heating device. For example, in the case of using an oil bath or the like, the temperature can be 80° C. or more and 150° C. or less.

3. Mixing step

This is a step of preparing a mixture B by, after the first refluxing step, mixing the mixture A having a temperature that is lower than that in the first refluxing step with a shell material.

The mixture A used in this step is the reaction mixture which has been subjected to the first refluxing step and which has a temperature that is lower than that in the first refluxing step. The mixture A having a temperature that is lower than that in the first refluxing step encompasses the mixture A which was cooled after the first refluxing step, and the mixture A which was allowed to stand after the first refluxing step and, as a result, was naturally cooled.

The reason for the use of such a low-temperature mixture A is as follows. That is, a shell can be more thinly and uniformly deposited on the core fine particle surface by adding the shell material to the low-temperature mixture A and gradually increasing the temperature in the below-described second refluxing step, rather than by adding the shell material to the high-temperature mixture A.

The shell material used in this step is not particularly limited, as long as it is a material that can deposit the shell on the core fine particle surface by being mixed with the mixture A and by the below-described second refluxing step.

A platinum or platinum alloy shell can be considered as the shell to be deposited on the core fine particle surface. Therefore, as the shell material, there may be mentioned platinum, platinum alloys, platinum compounds and mixtures thereof, for example. As a concrete example of the shell material, there may be mentioned hexachloroplatinic (IV) acid (H₂Pt(IV)Cl₆). The shell material can be mixed as it is with the mixture A, or it can be appropriately dissolved in alcohol or the like and mixed with the mixture A in the form of an alcohol solution.

4. Second refluxing step

This is a step of refluxing the mixture B obtained by the mixing step. In this step, the shell is deposited on the core fine particle surface.

At the time of refluxing, the heating temperature is the same as the first refluxing step.

At the time of refluxing, it is preferable to add an alkaline compound to the mixture B. The alkaline compound that can be used here is the same as the first refluxing step.

5. Other steps

After the deposition of the shell, filtering of the thus-obtained reaction mixture, washing of the thus-obtained core-shell catalyst, drying of the same, etc., can be carried out.

The filtering and washing are not particularly limited, as long as they are carried out by methods that can remove impurities without any damage to the core-shell structure of the thus-obtained core-shell catalyst. The drying of the core-shell catalyst is not particularly limited, as long as it is carried out by a method that can remove solvents, etc.

The core-shell catalyst produced by the present invention can be used as a catalyst for fuel cells.

### EXAMPLES

Hereinafter, the present invention will be described in more detail, by way of an example, a comparative example, a reference example and a reference comparative example. However, the scope of the present invention is not limited to these examples.

1. Production of Core-shell Catalyst for Fuel Cells

### Example 1

First, 1 g of 30% by mass palladium-supported carbon powder (Pd/C) and 0.5 L of ethanol (dispersion medium) were put in a beaker. The mixture in the beaker was stirred with a homogenizer to disperse the Pd/C in the ethanol, thereby preparing a Pd/C dispersion.

Next, a septum, a condenser and a three-way cock were connected with the three necks of a three-necked flask.

Then, the Pd/C dispersion in the beaker was transferred to the three-necked flask. A temperature-controlled oil bath was installed on a magnetic stirrer, and the body of the three-necked flask was immersed in the oil bath.

Next, a long syringe needle was connected with the end of a tube that was connected with a nitrogen cylinder, and another long syringe needle was connected with the end of a tube that was connected with a hydrogen cylinder. Hereinafter, the syringe needle of the nitrogen cylinder is referred to as “nitrogen needle”, and the syringe needle of the hydrogen cylinder is referred to as “hydrogen needle”.

First, the nitrogen and hydrogen needles were inserted into the septum. Next, the tip of the nitrogen needle was immersed in the mixture. Nitrogen bubbling was carried out by supplying nitrogen gas from the nitrogen cylinder at a flow rate of 100 mL/min for 30 minutes. Then, the tip of the nitrogen needle was pulled out of the mixture and, instead, the tip of the hydrogen needle was immersed in the mixture. Hydrogen bubbling was carried out by supplying hydrogen gas from the hydrogen cylinder at a flow rate of 50 mL/min for 30 minutes. The tip of the hydrogen needle was pulled out of the mixture and, instead, the tip of the nitrogen needle was immersed in the mixture. Then, nitrogen bubbling was carried out again in the same condition as above (bubbling step).

After the bubbling step, with temporarily increasing the supplied nitrogen amount, the septum having the two needles inserted thereinto was quickly changed for a thermometer. This is an operation to connect the thermometer with the three-necked flask, preventing the oxygen to enter the three-necked flask as much as possible.

Next, with stirring the Pd/C dispersion in the three-necked flask, the dispersion was heated to bring the dispersion medium to boil and refluxed for one hour (the first refluxing step).

Meanwhile, H₂Pt(IV)Cl₆ was dissolved in 21.8 mL of ethanol, thereby preparing a 0.05 M H₂Pt(IV)Cl₆ ethanol solution.

After the one hour of refluxing, the mixture was cooled until the temperature reached a range of 15 to 40° C. The 0.05 M H₂Pt(IV)Cl₆ ethanol solution was added to the cooled mixture (the mixing step).

With stirring the resulting mixture, the temperature of the oil bath was increased to 80° C. to bring the mixture to boil, and the mixture was refluxed for two hours (the second refluxing step). At this time, the temperature of the dispersion medium was 78° C. After the two hours of refluxing, 21.8 mL of a 0.1 M KOH aqueous solution was added to the mixture, and the heating was stopped.

After the heating, the mixture was cooled until the temperature reached a range of 15 to 30° C. Then, the mixture was filtered, and a solid thus obtained was washed with ethanol and water. Then, the solid was dried overnight under reduced pressure, at a temperature condition of 60° C.

The solid thus obtained was used as the core-shell catalyst for fuel cells of Example 1.

### Comparative Example 1

First, a Pd/C dispersion was prepared in the same manner as Example 1.

Next, a thermometer, a condenser and a three-way cock were connected with the three necks of a three-necked flask.

Then, the Pd/C dispersion in the beaker was transferred to the three-necked flask. A temperature-controlled oil bath and a magnetic stirrer were installed in the same manner as Example 1.

Thereafter, steps from the first refluxing step to the reduced-pressure drying step were carried out in the same manner as Example 1. That is, the bubbling step was not carried out in Comparative Example 1.

The solid thus obtained was used as the core-shell catalyst for fuel cells of Comparative Example 1.

### 2. Measurement of Oxidation-reduction Potential (ORP)

In the bubbling step of Example 1, using an ORP meter, the oxidation-reduction potential (ORP) of the mixture in the three-necked flask was measured at the following three points:

(a) During the first nitrogen bubbling

(b) During the hydrogen bubbling

(c) During the second nitrogen bubbling

FIG. 1 is a graph showing the transition of oxidation-reduction potential (ORP) in Example 1. The following Table 1 shows the oxidation-reduction potential values (V vs. RHE) of the mixture of Example 1 at the points (a) to (c).

TABLE 1

| | (a) | (b) | (c) |
|---|---|---|---|
| Example 1 | 0.38 | −0.10 | −0.05 |

In Comparative Example 1, using an ORP meter, the oxidation-reduction potential (ORP) of the mixture in the three-necked flask was measured at the following seven points:

(0) Just before starting the first refluxing step

(1) Just after finishing the first refluxing step

(2) Just after cooling the mixture after the first refluxing step

(3) Just after starting the mixing step

(4) Just after finishing the second refluxing step

(5) Just after adding the KOH aqueous solution

(6) Just after cooling the mixture after the second refluxing step

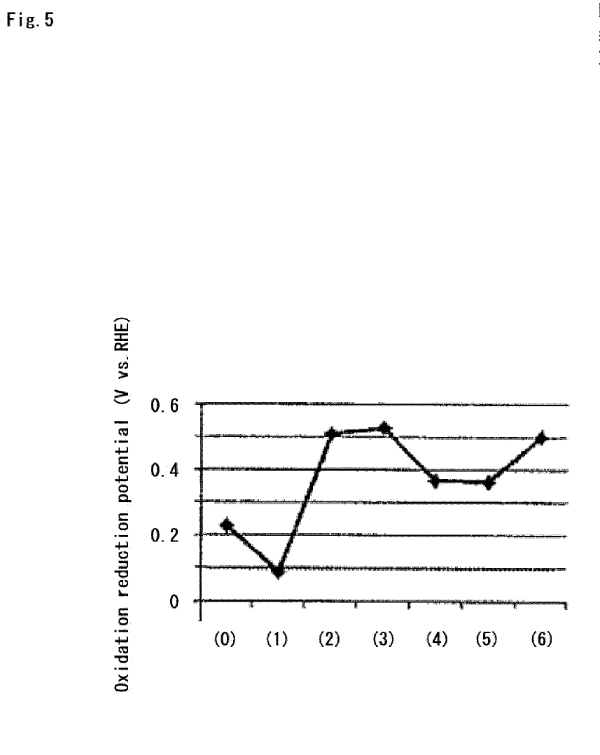

FIG. 5 is a graph showing the transition of oxidation-reduction potential (ORP) in Comparative Example 1. The following Table 2 shows the oxidation-reduction potential values (V vs. RHE) of the mixture of Comparative Example 1 at the points (0) to (6).

TABLE 2

| | (0) | (1) | (2) | (3) | (4) | (5) | (6) |
|---|---|---|---|---|---|---|---|
| Comparative | 0.23 | 0.09 | 0.51 | 0.53 | 0.37 | 0.36 | 0.50 |
| Example 1 | | | | | | | |

3. Measurement of Catalyst Mass Activity

The catalyst mass activity of the core-shell catalyst of Example 1 and that of Comparative Example 1 were measured by the rotating disk electrode (RDE) method.

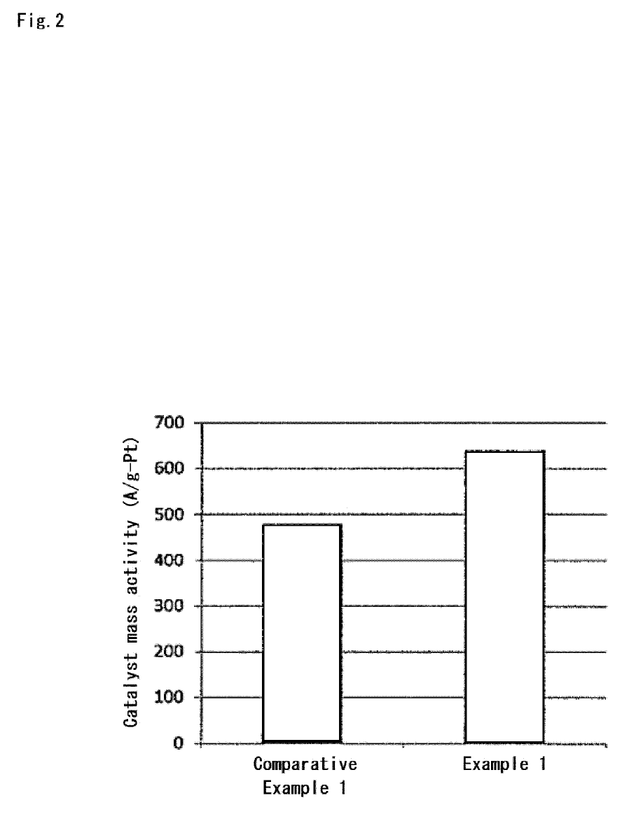

FIG. 2 is a bar graph comparing the catalyst mass activity (A/g-Pt) of the core-shell catalyst for fuel cells of Example 1 to that of Comparative Example 1. The catalyst mass activity shown in FIG. 2 corresponds to the specific activity of each catalyst in 0.1 M perchloric acid aqueous solution with respect to the oxygen reduction activity (ORR) of the same.

4. Measurement of Electrochemically Active Surface Area

(1) Preparation of Sample

### Reference Example 1

An appropriate amount of the Pd/C of Example 1, which was at the point after the bubbling step and before the first refluxing step, was sampled. The thus-obtained Pd/C sample was applied on an RDE, and the RDE on which the sample was applied, was immersed in 0.1 M perchloric acid aqueous solution. Ar bubbling was carried out on the perchloric acid aqueous solution in which the RDE was immersed, thereby saturating the mixture with Ar. The Ar-saturated mixture was used as the sample of Reference Example 1.

### Reference Comparative Example 1

The Pd/C material used in Comparative Example 1 was applied on an RDE, and the RDE on which the material was applied, was immersed in 0.1 M perchloric acid aqueous solution. Ar bubbling was carried out on the perchloric acid aqueous solution in which the RDE was immersed, thereby saturating the mixture with Ar. The Ar-saturated mixture was used as the sample of Reference Comparative Example 1.

(2) Cyclic Voltammetry

Cyclic voltammetry was carried out on the samples of Reference Example 1 and Reference Comparative Example 1, at a sweep rate of 50 mV/s.

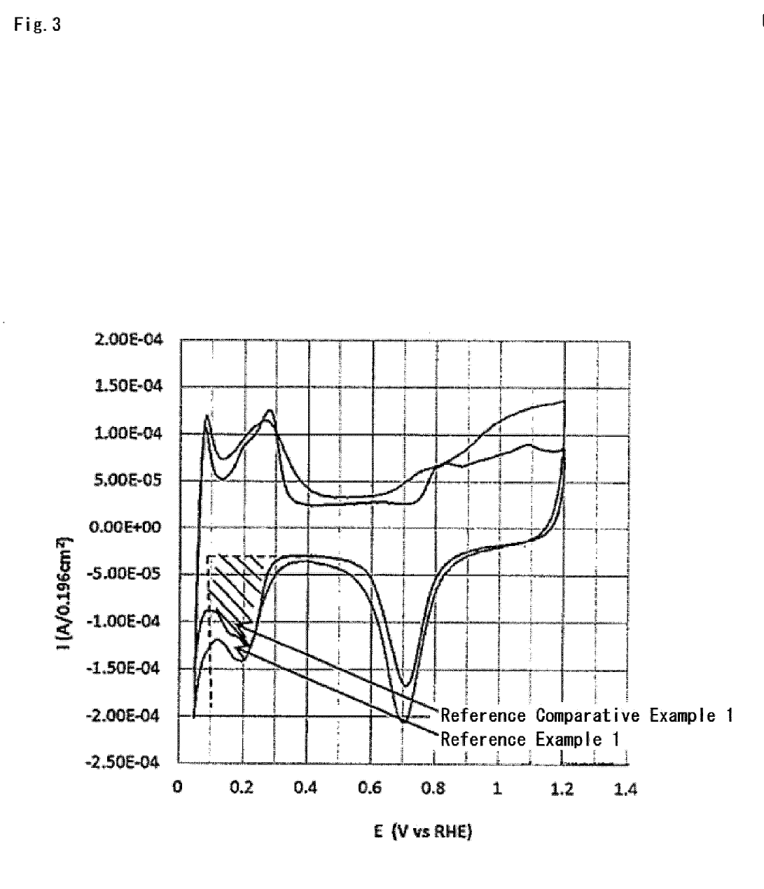

FIG. 3 is a view showing the cyclic voltammograms (CVs) of the samples of Reference Example 1 and Reference Comparative Example 1, which are overlapped on each other. Diagonal lines and dashed lines shown in FIG. 3 indicate the area of a hydrogen adsorption wave and the border thereof, with respect to the palladium in the CV of Reference Comparative Example 1.

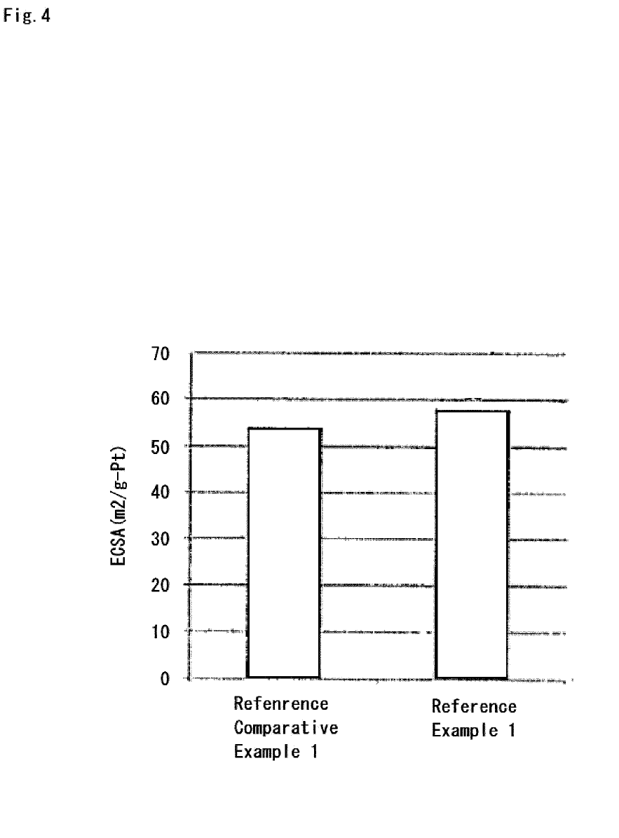

FIG. 4 is a bar chart comparing the electrochemically active surface area (ECSA) of palladium in the sample of Reference Example 1 to that of Reference Comparative Example 1. The electrochemically active surface areas shown in FIG. 4 were calculated from the area of the hydrogen adsorption wave shown in FIG. 3.

5. Consideration

First, as is clear from FIG. 5 and Table 2, in Comparative Example 1, the oxidation-reduction potential hovers around 0.1 V (vs. RHE) or more. In contrast, as is clear from FIG. 1 and Table 1, in Example 1, the oxidation-reduction potential is as low as −0.05 V (vs. RHE) at the time of finishing the bubbling step.

As shown by the diagonal lines and dashed lines in FIG. 3, hydrogen adsorption areas appear in a range of about 0.1 to 0.3 V (vs. RHE) in the CVs of FIG. 3. As is clear from FIG. 3, the hydrogen adsorption area in the CV of Reference Example 1 is larger than that of Reference Comparative Example 1. As is clear from FIG. 4, the ECSA of Reference Example 1 (58 m²/g-Pt) is larger than that of Reference Comparative Example 1 (54 m²/g-Pt).

As just described, the reason why Reference Example 1 is larger than Reference Comparative Example 1 in hydrogen adsorption area and ECSA, is as follows. That is, the Pd/C used in Reference Comparative Example 1 was obtained by carrying out the refluxing under a relatively high oxidation-reduction potential (about 0.1 V (vs. RHE) or more). Accordingly, it is presumed that oxides that could not be removed (such as PdO) were present on the palladium surface in the Pd/C. Meanwhile, the Pd/C used in Reference Example 1 was obtained by carrying out the refluxing under a relatively low oxidation-reduction potential (−0.05 V (vs. RHE) or more). Accordingly, it is presumed that oxides were cleaned away from the palladium surface in the Pd/C by the refluxing and, as a result, the hydrogen adsorption area and ECSA of the palladium were increased larger than ever before.

As is clear from FIG. 2, while the catalyst mass activity of Comparative Example 1 is 480 A/g-Pt, the catalyst mass activity of Example 1 is 640 A/g-Pt. As just described, the core-shell catalyst for fuel cells of Example 1 has the catalyst mass activity that is 1.3 times higher than the core-shell catalyst for fuel cells of Comparative Example 1.

Because of the above reasons, in Example 1 in which the bubbling step was carried out, the oxidation-reduction potential can be kept lower than Comparative Example 1 in which the bubbling step was not carried out, at the time of shell deposition. As a result, it has been proved that the core-shell catalyst which is excellent in catalyst mass activity was obtained.

What is claimed is:

1. A method for producing a core-shell catalyst for fuel cells,
wherein the method comprises:
a bubbling step of bubbling hydrogen into a mixture A containing a core fine particle-supported carbon and alcohol;
a first refluxing step of refluxing the mixture A after the bubbling step;
a mixing step of preparing a mixture B by, after the first refluxing step, mixing the mixture A having a temperature that is lower than that in the first refluxing step with a shell material; and
a second refluxing step of refluxing the mixture B.
